(19) United States
(12) Patent Application Publication
(10) Pub. No.: US 2015/0269507 A1
(43) Pub. Date: Sep. 24, 2015

(54) MONITORING OF PROFESSIONAL SERVICES PROJECTS

(71) Applicant: Micah Ascano, Woburn, MA (US)

(72) Inventor: Micah Ascano, Woburn, MA (US)

(21) Appl. No.: 14/244,477

(22) Filed: Apr. 3, 2014

Related U.S. Application Data
(60) Provisional application No. 61/955,036, filed on Mar. 18, 2014.

(51) Int. Cl. G06Q 10/06; G06Q 20/14

(52) U.S. Cl. CPC G06Q 10/0639; G06Q 20/14

(57) ABSTRACT

A system for monitoring a process of performing professional services. Data, representing measured values of a parameter of the process, are plotted as a time series with respect to control limits computed from historical variation in the process. The data series, and the control limits, may reflect differences between an observed value of a parameter of the process and actual values. The process parameter, for example, may be a cost of providing professional services. One or more signals may be detected based on the data and computed control limits and, in response to detecting such a signal, corrective action may be triggered. Such corrective action may include adjusting the process of providing professional services, identifying and correcting errors causing deviations from an expected process or changing predictions of costs or identifying deviations from an expected process for performing the professional services.

### BACKGROUND

A control chart is a technique to track statistical variation among a set of data of the same type, such as to evaluate a process for quality control purposes. Values for some parameter of the process are measured and plotted on the control chart. Based on historical data, showing variance in the measured parameter, control limits may be computed and reflected on the chart. The control limits reflect the expected range of values for the parameter if there is an absence of special cause variation.

As the process operates, and more measurements are taken, those measurements may be added to the chart. Measured values outside the control limits may signify a change in the process that may reveal a problem or indicate the need for corrective action.

For example, the same part created with the same machine could be measured, and those measurements could be put into a control chart to track variation in manufacture of the part. In such processes, normal or common cause variation may be measured, allowing for any deviation outside of the control limits or special cause variation to be easily identified. As an example of special cause variation, if a die in the machine becomes worn, the shape of the part may deviate from the desired shape. A control chart might present data on a part dimension that will help an operator distinguish between expected variation in part size and a die that has become worn to the point of warranting correction.

### SUMMARY

Described herein is a technique for monitoring projects relating to professional services, such as legal services. In accordance with some embodiments, data, representing project cost, is presented on a control chart. In some embodiments, the data may be presented as a deviation with respect to a budget.

Such a technique may be embodied as a method of monitoring a project. The techniques described herein may alternatively or additionally be embodied as a non-transitory computer readable medium adapted to prepare and present such a control chart. Alternatively or additionally, such techniques may be embodied as a system that collects data, generates and/or uses such control charts.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of a simplified system for monitoring projects in accordance with some exemplary embodiments.

FIG. 2A is a graphical representation of a control chart for a data series representing a difference between actual and predicted costs.

FIG. 2B. schematically illustrates a data series used in preparing the control chart of FIG. 2A.

FIG. 3 is a graphical representation of a control chart where the centerline deviates from the x-axis.

FIG. 4 is a graphical representation of a control chart with an out-of-control data point.

FIG. 5 is a graphical representation of an individual control chart in which a series of several points are below the centerline which are used to calculate different control limits and centerline values in FIG. 6.

FIG. 7 is a graphical representation of a control chart where the percentage difference is graphed and analyzed.

FIG. 8 is a flowchart for a process of the possible steps involved in implementing a control chart into evaluating predicted costs estimates.

FIG. 9 is a schematic of the exemplary computing devices and computing accessories that may be involved in an electronic tracking system.

### DETAILED DESCRIPTION

The inventor has recognized and appreciated techniques that enable improved management of professional service projects via monitoring using a control chart. Such projects may include multiple tasks, and average values of a measured parameter of the process may be different for different tasks. A control chart prepared using conventional techniques from such data may not reveal appropriate insights about the process. Presenting cost data for multiple tasks, for example, may not yield meaningful information, because it would present dissimilar data points based on values measured during different tasks. In making a control chart for such a process, the normal variation is difficult to identify among the data set. As a result, any special cause variation in the process cannot be determined from the common cause variation.

Such highly variable processes are likely to occur when project-based services are rendered to a client. For example, legal work, even on the same type of project, can vary significantly from project to project in the time it takes to complete a particular task. Such variability can prevent control charts from providing any useful information because it becomes difficult to tell whether measurements outside of the control limits are indicative of a problem with the project or work done on different tasks. This variability in the costs associated with work, and the lack of tools to monitor processes with such variability may also lead to a reluctance among lawyers to use flat fees or estimate budgets because each case cannot be directly compared to the next.

The inventor has recognized and appreciated that valuable insights may be obtained by preparing a control chart for a parameter representing a difference between the value of the project parameter and a planned value of that parameter. As a specific example, the parameter may be cost, and the control chart may reflect variations in the actual cost relative to a budgeted cost. Accordingly, described herein is a tool for implementing statistical quality control with budget tracking, analysis, and prediction, including for monitoring a process, such as a professional services project. Such a tool may be implemented as computer-executable instructions structured to perform methods as described herein and to render control charts, reports or other outputs to a user and/or to take automated actions to address performance problems.

The discussion that follows relates primarily to the application of such a tool to process improvement in a legal setting. However, the invention has applications in other fields of use where predicted and actual costs or other project parameters are available for comparison and monitoring.

Service providers that charge the client based on billable hours, such as in the legal field, may use such a tool to improve the overall efficiency of their process of delivering services. Such improvements may reduce costs to the client and allow the service provider to remain competitive. Additionally, it may enable the service provider to use a flat fee structure for service pricing and associated operational cost. Flat fee or alternative fee arrangements may be attractive to the client because the cost for a given service is certain, which may lead to more business for the service provider. However, one reason legal professionals are deterred from adopting a flat fee is due to the inherent risk of losing money when the actual costs are larger than the predicted costs for a service when setting the fee. Such a risk may be reduced by accurately monitoring and analyzing costs associated with services, by using a tool and method as described herein.

As part of achieving improved efficiency and determining accurate predicted legal budgets, values of a parameter representative of legal work may be accurately collected, tracked, and analyzed to determine differences between the predicted value of the parameter and the measured value of the parameter, such as differences between cost estimates and the actual cost of a service. Monitoring in this way may identify, and allow corrective action to reduce, special cause and/or common cause variation in the legal work process, and increase predictability. Reducing variation in turn may improve the accuracy of the budget provided to a client. An increase in predictability may allow for increased use of alternative fee agreements and increased profit margins.

In the field of legal services, not every law firm provides services to clients in exactly the same way. While the overall process may be similar from firm to firm, the execution steps and business practices vary by preference and other factors. Wide variations may occur among law firms or other service providers of the same field. Accuracy of predictions may be improved by developing a baseline that against which process improvements may be measured. Data for the same type of work or service may be collected over time to create a sample that is then statistically analyzed and presented in a control chart. From the control chart, a service provider may identify common cause variation that may be addressed with process changes or improvement. For example the service provider may identify that it lacks standardized forms that could aid in performance of a specific task such that its process might be improved by standardizing on forms across its organization. The control chart may alternatively or additionally reveal special cause variation, indicating that there is a problem in the way the process is being implemented in a specific case, leading to an investigation and possible solution to ongoing problems. For example, special cause variation may indicate that a worker who is not trained for a task being assigned to perform that task.

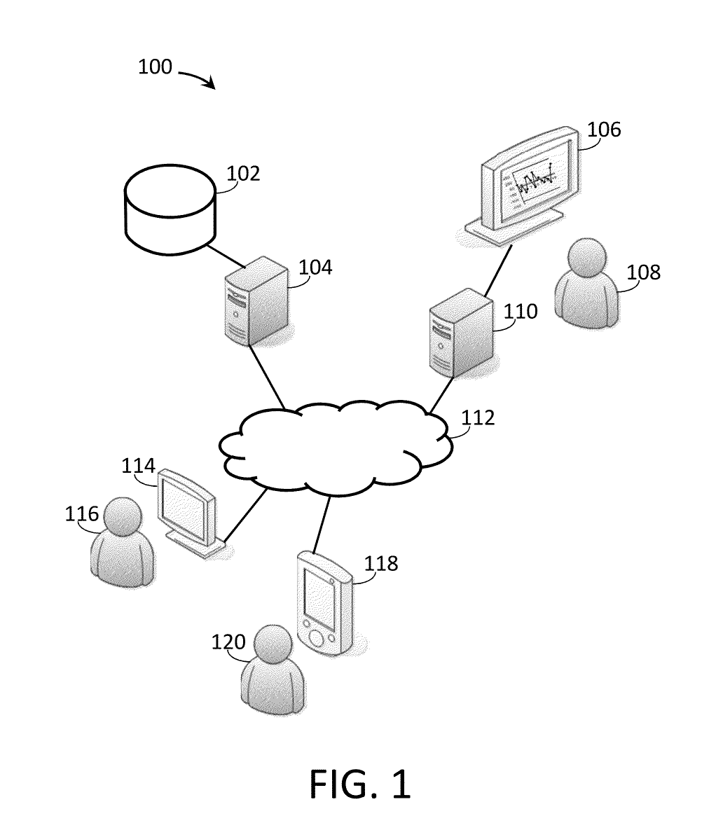

An example of a monitoring system 100 is shown in FIG. 1. A worker, such as workers 116 and 120, may enter data relating to project performance in a computing device, such as a desktop or laptop computer 114 or a personal digital assistant (PDA) or smartphone 118. In this example, two workers are shown for simplicity. However, any suitable number of workers may be involved in providing professional services.

Additionally or alternatively, computing devices 114 and 118 may collect data without direct worker input. Collected data may include time sheets and/or the billing rate during when the work was completed. Alternatively or additionally, the work may include tasks completed or progress on tasks. However, it should be appreciated that any suitable data, indicative of performance of a professional services project may be collected.

Moreover, the professional services may be any suitable type of professional services. For example, the professional services may be legal services.

The data may be collected and stored in the database 102 automatically. Such a database may be part of a time tracking system as known in the art for use in a law firm. In some embodiments, a database may be part of a billing system as known in the art. However, any suitable database may be used.

To facilitate automatic data storage, computing devices 114 and 118 may be connected to a network 112 and stored in a computing device 104 with a database 102. Such a database 102 may store data from all or a subset of workers. The database 102 may also store data consisting of predicted costs for the services being provided.

A manager 108 may access the data from the database 102 through the network 112. Statistical analysis of the data may be performed on a computing device 110 and reviewed by the manager 108 through a user interface such as a computer monitor 106. In some embodiments, the analysis may be performed automatically. In some embodiments, the analysis may result in generation of one or more control charts, as described herein, for display to a user of the system. In other embodiments, the computing device 110 and user interface 106 may alert the manager 108 to a concern that needs to be addressed. In some embodiments, system 100 may generate a suggested corrective action to be implemented by the manager. Such corrective actions over time may improve the overall process of the work.

Data for analysis may be collected in any suitable way. In some embodiments, methods as described herein may be implemented as computer-executable instructions that are executed on a computing device that has access to data about the performance of a process by workers who perform professional services on behalf of a service provider. In some embodiments, an electronic tracking system may be used to monitor values of one or more parameters associated with performing legal work. Parameters for which data may be collected as part of the monitoring, for example, may be the time taken to complete legal tasks, the billing rate of the work, and any other associated costs. Electronic tracking systems of this type are known in the art. For example, many law firms include a time tracking and billing system. Some embodiments as described herein may be implemented as an add-on to such a system. Alternatively or additionally, in some embodiments, separate software may be written, and may access data stored by such a system. However, the specific mechanism by which values for specific parameters are acquired is not critical to the invention.

Each of these parameters may have a planned or budgeted value associated with it, and might be directly presented in a control chart or otherwise used in statistical analysis. Alternatively or additionally, values of one or more of the measured parameters may be combined to generate values representative of cost or some other derived parameter. Whether measured directly or combined to yield a derived parameter, the values may be compared to forecasted values for presentation on a control chart or other statistical analysis. For example, predicted costs may be determined based on the legal needs of the client and having legal providers estimate the time associated with addressing those needs based on their experience. Predictions for services provided may be determined in any suitable way. Additionally or alternatively, the process of completing the legal work may be standardized to minimize unnecessary variation. In some embodiments, such standardization of the process may allow for comparison that may lead to reducing variation in the process.

For example, the predicted cost and/or time associated with a given task may be monitored by the electronic tracking system. The electronic tracking system may also monitor billing rate when the work occurred. Such an electronic tracking system may be used for analyzing past tasks and the progress of current tasks. For example, an electronic tracking system may generate reports, such as total hours spent on a particular type of work that may be used to monitor overall business. Additionally or alternatively, an electronic tracking system may send messages to alert a user or manager about a particular task. As an example, the electronic tracking system may alert a manager if a particular task is reaching beyond a set limit on cost of a task. If the variation between predicted versus actual costs is monitored, the electronic tracking system may compute the difference and use it as a data series for a control chart.

A control chart may be presented as a graphical display of a quality characteristic either measured or computed from a sample versus the sample number or time. The control chart may be based on a series of average values, ranges, differences between values, or a series of some other function of the raw data. The series may be a time series where the data is acquired over a period of time. However, the series may be a number series where the time when the data was acquired may be irrelevant. The number of data points in the series is not critical to the invention. However, more data points or values in the series may yield a more statistically accurate control chart.

It should be appreciated that a control chart need not be depicted graphically. Such a depiction may aid in human analysis of variation. However, it is not necessary that the data be presented graphically or that the analysis be done manually. In some embodiments, automated analysis may be performed on the variation data to generate information about professional service projects that have been or are planned for performance and/or a service provider's processes for providing professional services.

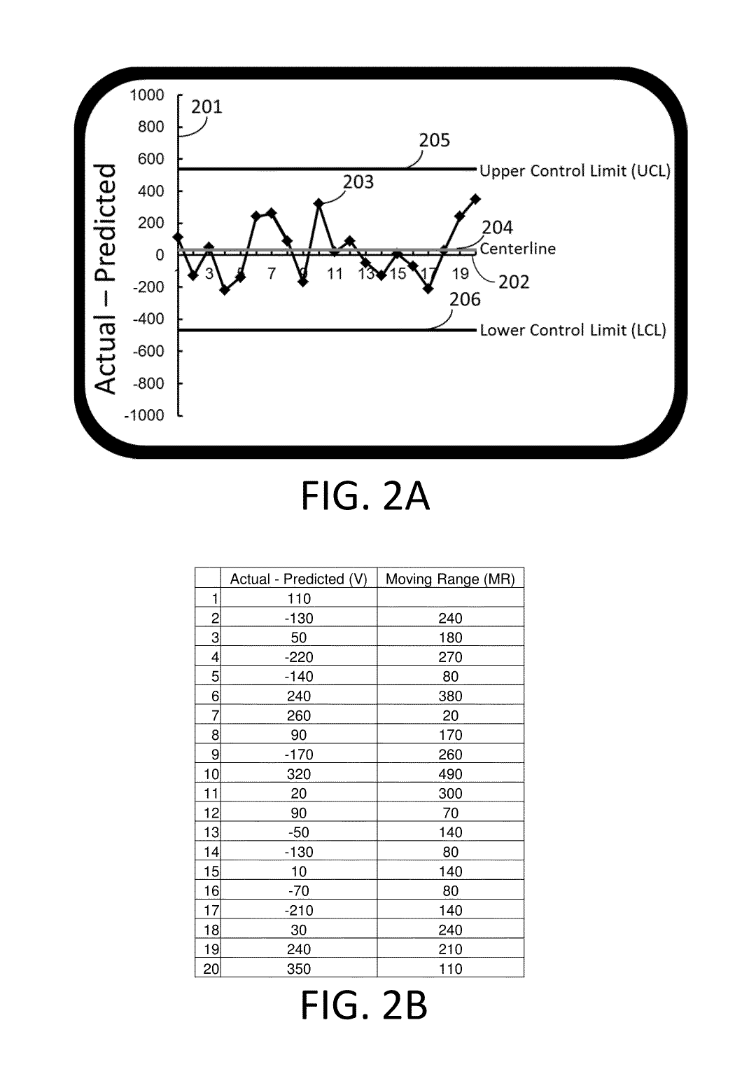

FIGS. 2 through 7, illustrate control charts that might be formed using techniques as described herein. Those figures also illustrate insights that might be obtained from analyzing data. In the example of a control chart shown in FIG. 2A, the difference between actual and predicted costs 201 is plotted versus the sample number 202 for a series of data 203. The control chart may contain a centerline 204 that represents the average value of the quality characteristic. Such a centerline may be added as a visual reference for detecting shifts or trends away from the average value of the data series. There may be two additional lines shown on the chart corresponding to an upper control limit (UCL) 205 and a lower control limit (LCL) 206. Such control limits may be placed equidistant on either side of the centerline.

While there are several different types of control charts, they may have similar interpretations although they may reveal different aspects of a process by characterizing the behavior of a data series. Some series are predictable, consistent, and stable, at least within limits, over time and may be said to be well-behaved. Such data series may allow predictions to be made for how the process might behave in the future by using past experience.

While interpreting a data series, point to point variation may lead to confusion in determining how to differentiate between the statistical noise of the process, which contributes to common cause variation, and a deviation from how the process has been operating in the past, which may contribute to special cause variation. Incorrect or lack of statistical analysis of the variation within a data series may lead to confusion in interpreting the data. First, the individual may interpret the common cause variation of the process as a meaningful departure from the past by interpreting the noise as if it were a signal of a change in the process. Such an interpretation may lead to actions which are inappropriate or contrary to the proper course of action. Second, an individual may not recognize when a change has occurred in the process by failing to detect when a signal outside the noise is present. As an example, the underlying process changes, but the values are within the specification limits so it is not readily apparent. Using a control chart may lead to reduced occurrences of confusion in interpreting the data series because the control limits allow an individual to make meaningful analysis of the data. When a process has deviated, the data point may fall outside the control limits or the data may form non-random patterns of variation around the centerline, which may also be recognized (either by an individual viewing the control chart or automated analysis of data).

The lines on the control chart provide reference points for use to delineate the type of behavior for a given series. When a data series remains within the control limits (UCL and LCL) and there are no multi-point sequences of points above or below the centerline, then the process may display a reasonable degree of statistical control, as shown in the example of FIG. 2A. Unless the process is changed in some fundamental way the process will continue to function between the upper and lower control limits 205, 206 with the average being the set average point indicated by the centerline 204.

These lines are computed based on statistics that may allow interpretation of the data series 203. As an example, the range of three standard deviations (σ) from the sample mean ( V̅) may be used to compute the upper control limit (UCL) and the lower control limit (LCL) by using the following equations:

UCL=VBar+3σ

LCL=VBar−3σ

In some embodiments, an estimation of the standard deviation value for the data series may be used in calculating the upper and lower control limits. An example of an estimate used for calculating the standard deviation may be based on the range of values within the data sample of n data points. The values for the upper and lower control limits depend on the data point-to-data point variation by computing the differences between successive values called moving ranges. In some embodiments, the moving range (MR) of two successive data points may be used as the basis for estimating the process variability. A moving range, MR, is calculated by taking the difference between successive data points and may be represented by the equation:

MRᵢ=|xᵢ−xᵢ₋₁|i=2,3, . . . n

An example of moving range calculations between two successive points are shown in FIG. 2B and are used to plot FIG. 2A. The average moving range ( M̅R̅) may then be calculated and used to estimate the standard deviation by calculating the ratio of M̅R̅/d₂, where d₂ is a statistical constant based on the ratio of the range over sample observations (i.e. the difference between the largest and smallest sample observations) to the sample standard deviation. In addition, d₂ depends on the sample size for the range. For a sample size of 2, d₂=1.128 and may be used when two points are used to calculate a range. When moving ranges are used to determine the control limits, the upper and lower control limits may be calculated using the following equations:

$$UCL = VBar + 3 * \frac{MRBar}{1.128}$$

$$LCL = VBar - 3 * \frac{MRBar}{1.128}$$

In calculating these control limits, the number of data points in the series may influence these calculations. As an example, the uncertainty in the computed limits may decrease as the number of data points used to compute the control limits increases. However, useful limits may be constructed with fewer data point values. In some instances, special cause variation may be associated with at least one data point. Such data points identified as driven by special cause variation may not be used to calculate the control limits.

The techniques involved in making an individual control chart may be used in an electronic tracking system for monitoring the variation in legal work. An example of an output from such an electronic tracking system is shown in FIG. 2A. In this example, a computing device may generate a control chart by computing the difference of the predicted legal cost versus the actual cost throughout a legal services project, and shows the range of variance. The data series, V, for the difference of actual and predicted costs plotted in FIG. 2A are also shown in FIG. 2B. The average value for the data series, V̅, may be computed and used to determine the control limits. The moving range values, also shown in FIG. 2B, would be the differences V(1)−V(2), V(2)−V(3), V(3)−V(4), and so on until there are no more data points in the series as described above. The average value for the moving range values, M̅R̅, may be computed and used to determine the control limits 205, 206 using the above equations. These calculated values for upper and lower control limits are included in the control chart and may be used for interpreting the variance of the data series 203 by a user.

FIG. 2A is an example control chart where each point in the data series 203 is the difference between predicted and actual costs for a service provided to a client. The difference between the predicted and actual costs is plotted on the y-axis 201 while the x-axis 202 indicates a point series such that the data series is sequentially plotted.

The data series may be a time series and the x-axis may have a unit of time such that individual points are arranged based on when the service occurred or was completed. Time in this context may be represented as a calendar time, showing costs, for example during sequential days, weeks, months, etc. Alternatively or additionally, time may be indicated based on when tasks in a project are completed. As each successive task is completed, the cost of performing that task may be compared to the budgeted amount and presented as a data point.

In this example, the data that comprise the series is of the same type to allow for comparison. The centerline 204, representing the average value of the data series 203 is shown. The upper control limit 205 and lower control limit 206 are also shown. As drawn, the data series are within the upper and lower control limits, indicating that the data series is stable. As a result, the data series is predictable within this range and the centerline indicates the average value of deviation.

This data may be used in any suitable way. An electronic monitoring system may use the control chart to monitor for points outside the control limits, shifts, trends, patterns, variation, and precision of additional data points. The information from the control chart may be used in any one or more ways, such as to improve budgeting methods, identify areas where the overall process can be improved, and/or assist in identifying elements that drive variation and increase or decrease cost.

An electronic monitoring system may receive user input in creating an individual control chart. The electronic monitoring system may aggregate numerous inputs across professional services into data points for one or more data series, which may then be processed. A user of the electronic monitoring system may supply input that controls the manner in which data is aggregated into a data series. For example, after a data point representing a completed legal task is generated, the user may manually approve it prior to being added to the data series. For example, the user may determine that a particular data point is more relevant to another data series and the electronic monitoring system may move the data values accordingly. The user may be able to select which data points are used for analysis. As an example, the user may not want the most recent data point to be aggregated into the calculations for the control limits so as not to skew the control limits prior to comparison. The electronic monitoring system may have an option to preview the control chart with the additional data point prior to recalculating the control limits.

The centerline of the control chart may be used for predicting the average value for the process illustrated by the control chart. When the control chart is used to plot the difference between actual and predicted costs, as shown in FIG. 2A, the centerline 204 is the average value for how the actual costs differ from the predicted costs. In the example in FIG. 2A, a positive value for the centerline indicates the actual costs are larger than predicted. Examining where the centerline falls may be useful in developing an overall strategy for future predicted costs. As an example, if a service provider is trying to develop predicted costs that on average are the same as the actual costs, then it may be desirable for the average value, and thus the centerline, to be as close to zero or the x-axis 202 as possible, such as the control chart shown in FIG. 2A. If not, a legal services provider might either alter the way budgets are generated or services are preformed to reduce this average difference.

On the other hand, the average value of the difference may be close to zero. Based on such a control chart, legal service providers may decide to implement flat or alternative fee arrangements based on the predictability of the actual costs being, on average, equal or close to equal to the predicted costs. In some embodiments, it may be desirable to have the centerline be above or below zero as part of developing a budgeting plan. As an example, it may be appropriate for the centerline to be slightly below zero to ensure that on average the actual costs are lower than the predicted costs. Such examples may ensure that there is an overall net profit in the budget estimation process and may be useful in the early stages of using control charts to monitor budgets.

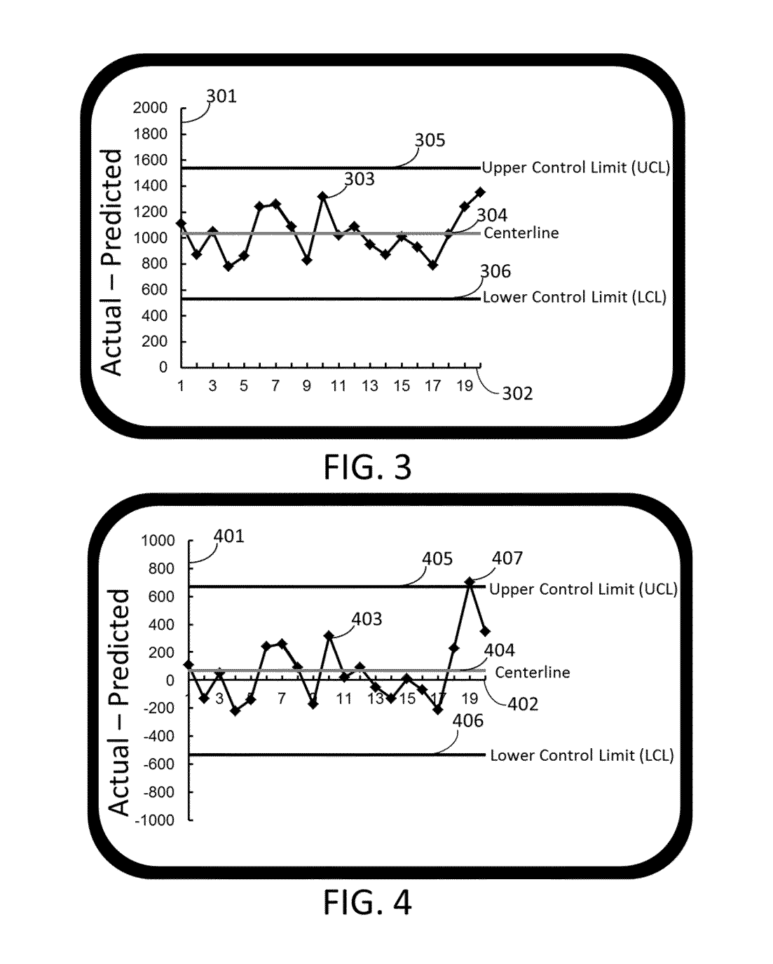

The centerline may also be used to evaluate the method of predicting costs for services. When the control chart plots the difference between the actual and predicted costs for different service occurrences of the same type, the centerline displays how well the predicted or estimated costs match the actual costs of providing the service. Such a chart can show if the average prediction is higher or lower than the actual costs so that the prediction methods can be adjusted for better accuracy. As an example, if the difference between the actual and predicted costs are consistently above or below zero, the centerline will reflect this by being away from the x-axis. FIG. 3 shows example data 303 where the average value 304 for the difference between the actual and predicted costs for the same type of legal service is above zero. As plotted, this control chart shows that on average the actual costs are higher than the predicted costs. If improving the accuracy of budget estimates is desired, such as to develop flat or alternative fee arrangements for legal services, it may be decided by the service provider to adjust future predicted costs for the same type of service by the average value indicated by the centerline. In the example shown in FIG. 3, future predictions could include an extra $1000 in the estimate in order to readjust the control chart closer to the x-axis. Future actual costs for this type of service may be closer to the adjusted predicted costs. If so, this may be validated via a control chart when the additional future data points are included.

The amount of variation shown by the control limits may reflect a range of values for the entire process. In embodiments where the difference between predicted and actual costs for a legal service are determined, the difference between control limits may be the variation between the actual and predicted costs that can be expected. The smaller the difference between the control limits, the more consistent the difference between the predicted budget and the actual cost. When the range is larger, the difference between the predicted and actual costs may be more variable and cover a broader range of values.

When the control limits are calculated based on the data, the variability may be altered by changing the underlying process of conducting the legal service. If the variability is undesirably large, the underlying process may be examined to gain an understanding of this variation. In the field of legal services, this may involve examining itemized costs, time spent on tasks, or reevaluating whether the appropriate people are handling certain tasks as part of the overall service. The difference between the limits may indicate how steady the process is or the normal operating range for the process. Change of this difference may be made by making changes in the underlying process.

Once the routine variation in a process has been established, including by making process adjustments, the process may be monitored using the control chart. When a particular data point falls outside the range set by the control limits, that data point may not be due to random variation of the process and may be a signal of some aspect of the process differing from how it was planned or performed in the past. Accordingly, one or more data points outside the control limits may trigger an examination of such “out-of-control” points to find a cause for their deviation. Such an examination may reveal changes that can be made to prevent a problem from reoccurring. Alternatively, such “out-of-control” points may be a warning of a possibly significant deviation in a future data point.

An example of a single data point going beyond the control limit is shown in FIG. 4. Data point 407 is above the upper control limit 405 in the individual control chart. This data point 407 may be interpreted as being a significant departure from the other data points. Since this example is a control chart for budget variation in legal service, data point 407 signifies that the actual cost of the service differs from the predicted range set by the control limits. As plotted in FIG. 4, data point 407 exceeds the upper control limit 405 and indicates that the difference between the actual and predicted costs is larger than the range set by the control limits. In this example, the actual costs are larger than the predicted costs by an amount that cannot be explained simply by normal variation. As noted above, such a data point 407 may signify a need to investigate the manner in which the budget for one or more tasks was set and/or the manner in which professional services were performed to identify a cause of the difference. Such an analysis technique of an “out-of-control” point may be used with control limits calculated previously without the “out-of-control” point. In such embodiments, the control limits may indicate the desired variation of the process.

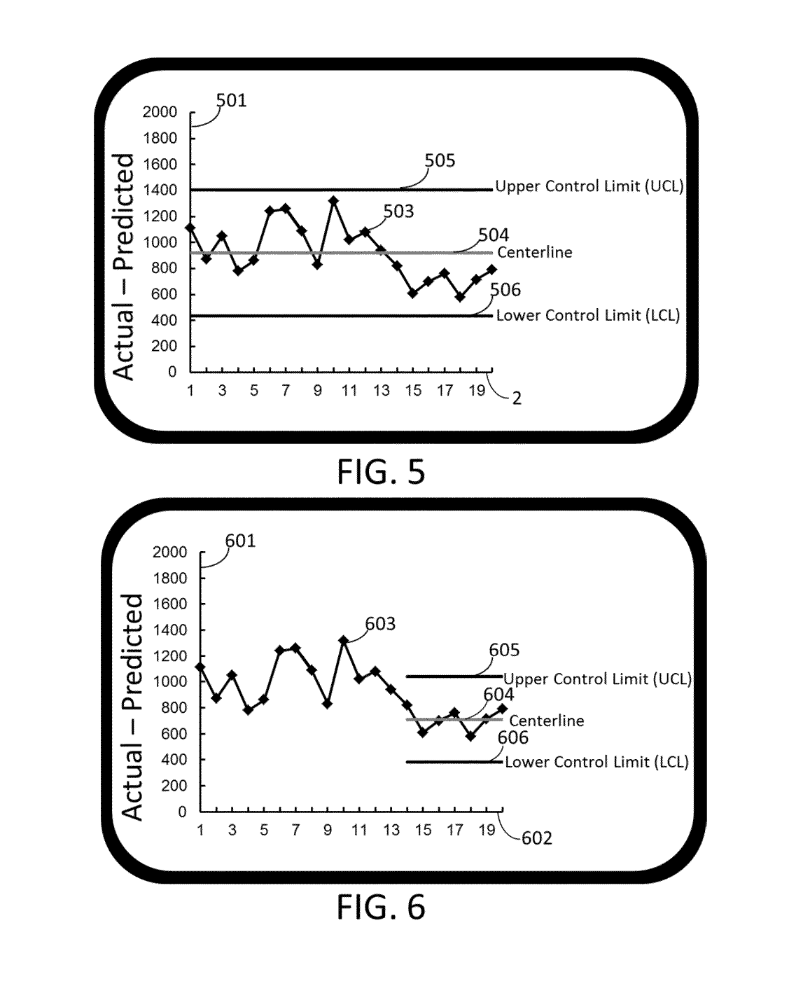

Another pattern which may be taken to be a signal that may trigger action is when a data series 503 is within the range set by the control limits 505, 506 but has several consecutive data points on one side of the centerline 504, such as shown by points 14-20 of the data series 503 in FIG. 5. In some embodiments, a signal may be detected based on a majority of consecutive points, such as three out of four, being on the same side of the centerline. Other embodiments may further determine that a signal occurs when consecutive points are closer to one of the control limit values than to the average value. This may indicate a shift in the underlying process represented in the control chart. If the data is a time series, the change may have occurred as early as the earliest point among the consecutive data points on the same side of the central line, or may have occurred earlier than the first data point. When this pattern is observed, one or more corrective actions may be taken, including adjusting the process or the manner in which budgeting is performed.

An example of this type of pattern is shown in FIG. 5 in an individual control chart for the difference between actual and predicted costs. In this example, all the data points 503 are within the upper and lower control limits 505, 506. However, the last seven points in the series (points 14-20) are all on the lower side of the centerline 504. This may be a signal of a shift in the process shown in the control chart, which may indicate a systemic change in the underlying process. Such a change may warrant corrective action in the way the process is performed and/or the way in which process parameters are predicted.

If the manner in which predictions are made is changed, it may be useful to re-calculate the average and control limits. FIG. 6 shows the re-calculated centerline 604 and control limits 605 and 606 for the region of the control chart where this change has been observed, data points 14-20. Such re-calculated values for the average difference between actual and predicted costs and the upper and lower control limits may then be used for future predictions and data points. This technique may be used to track overall progress of reaching a long-term goal. As an example, a service provider may plan to meet certain predicted cost estimates and may want to lower the difference between predicted and actual costs for a particular type of service. The service provider may institute changes into the overall process, such as reallocating resources and people, improving efficiency, etc., but may be unsure of how such actions impact the overall goal. Observing several consecutive points where the difference between actual and predicted costs are lower than average may indicate the actions are achieving such desired change. In this example, the average and control limits may be recalculated. The new average value and control limits may then be incorporated into tracking whether the actual costs are closer to the predicted costs. In some embodiments, the new average and control limits may also be used to change the predicted cost for future services to clients. In such examples, the overall change in the underlying process is reflected in the predicted cost. If flat or alternative fee arrangements are a goal, this shift in the process may be reflected in the fee to the client.

This type of technique may also be used in interpreting an out-of-control point. As part of this technique, it may be useful to examine the sequence of points adjacent to the out-of-control point. If they are on the same side of the central line as the out-of-control point, then it may indicate a change in the process. In some embodiments where the control chart is a time series, the change may have begun as early as, or before, the earliest point on the same side of the centerline as the out-of-control point. It may be useful to re-compute the control limits for the region where there is a change and use them to evaluate future for signs of improvement or deterioration in the process.

The above techniques may also be used for evaluating a process or work currently underway. In examples where budgets are evaluated, while the work is still in progress, it may be beneficial to check whether the cost of the work is within the range set by the upper and lower control limits. In some embodiments, it may be worthwhile to project the final costs from the current status to evaluate whether the cost of the work is within the predicted range. Such a process may provide an early warning when legal work may extend beyond the bounds of the predicted values of one or more parameters. If a cost limit is approached or surpassed, for example, corrective action may include meeting with the client to discuss how to get the legal work back on budget.

In some embodiments, a difference between actual and predicted value of a parameter may be plotted on a linear scale based on the magnitude of the difference. However, a difference may be reflected in any suitable way. In some embodiments, an individual control chart may be created to depict a proportional difference as the data series. In some embodiments, the data series may be a percentage deviation between the predicted cost and the actual cost. In such examples, the difference between the actual cost and predicted cost is normalized, such as by dividing by the predicted cost. Such normalization may allow for a more accurate analysis of the individual control chart when the cost amount between each service occurrence varies. As an example, in a control chart that plots the absolute difference between actual and predicted costs, $1,000 off a $2,000 predicted cost would appear to be the same as $1,000 off a $100,000 predicted cost. In such an example, the service provider may not be as concerned about the deviation from the $100,000 prediction and may want the control chart to reflect such a preference. In such an example, the service provider may find more value in examining the percentage deviation from the predicted cost. Using this technique where the difference is divided by the predicted cost, the above example would have a 50% deviation for the $2,000 predicted cost and a 1% deviation for the $100,000 predicted cost.

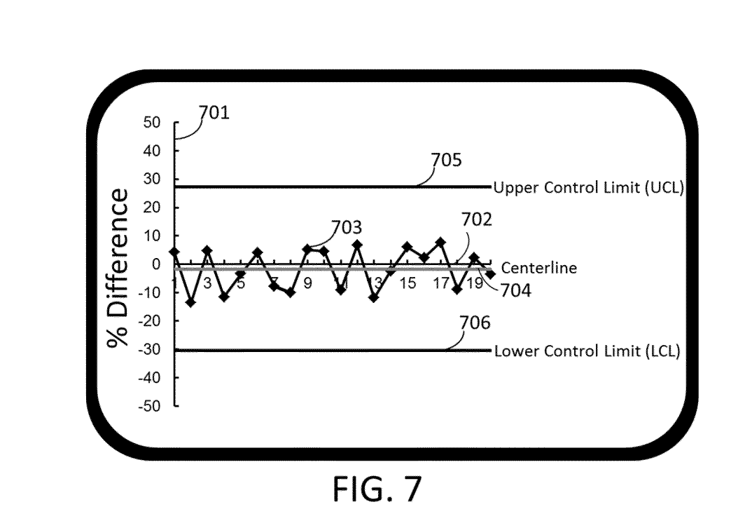

The same steps may be used to form an individual control chart where the percent or proportional difference is plotted instead of the absolute difference. An example of such a control chart is plotted in FIG. 7. In such a control chart, the y-axis 701 is a percent as shown in FIG. 7 while the x-axis 702 indicates the number and/or time of the data series 703. In some embodiments, the y-axis 701 may be a ratio value, such as between 0 and 1. In normalizing the difference between the actual and predicted costs, the predicted cost value may be used as described above. In some embodiments, the normalization may occur by dividing the difference between actual and predicted costs by the actual cost value. The percentage or proportional data series is the input for creating the control chart. In the example shown in FIG. 7, the centerline 704 and control limits 705, 706 are percentage values that represent the overall process. The centerline is the average percentage deviation from the predicted cost. The control limits indicate the range of percentage deviation from the predicted cost that the may be expected in the future. In the example shown in FIG. 7, a negative percentage indicates the predicted cost is higher than the actual cost.

Such a control chart may be used to impact the way legal services are provided. In the legal service field, the costs associated with a service may vary significantly and using a control chart with a proportional difference instead of an absolute difference may more readily reveal a need for corrective action. In some embodiments, such a control chart may be used to evaluate budget predictions. The centerline may be used to shift overall budget predictions. As an example, if the centerline indicates budget predictions are on average 5% too low, future budget estimates and predictions may include an added 5% to shift the overall future average value. Such a technique may be applied if the underlying process in the actual costs does not change.

The techniques described for using an individual control chart may have particular benefits from creating a plot to track the accuracy and consistency of budget estimates. In legal work, such techniques may identify and reduce variation in the overall process by tracking variation in legal work. A control chart may be used to increase predictability for budget estimates. Such predictability may allow for an increased use of alternative fee arrangements, such as flat fees, where the control chart may increase the confidence of using such an alternative fee arrangement for services. In some instances, the control chart may be used for increasing profit margins because average actual costs for services may be easier to predict. Additionally, a control chart may be used to improve overall efficiency in the process of providing the service. Such efficiency may amount to savings by the service provider in the form of extra profit and/or the additional capacity for more clients.

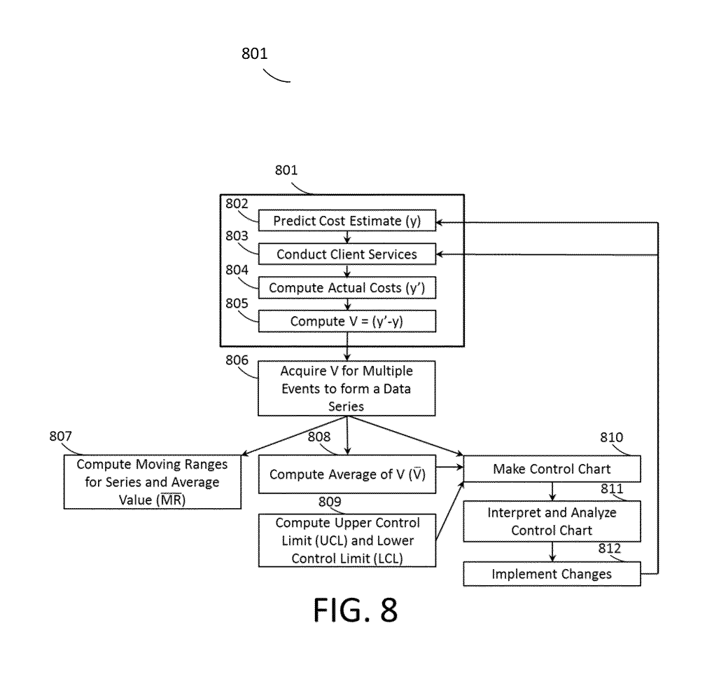

An example of how a control chart may be implemented into a budget development process is outlined by process 800 in the flowchart shown in FIG. 8. An electronic monitoring system may perform all or any portion of the steps of process 800. Block 801 includes steps that may occur for each instance or data point of a service type. A predicted cost for the service type is estimated by block 802. Such a prediction may include techniques such as determining the needs of the client and having the service providers estimate the time associated with addressing those needs based on their experience. In some embodiments, the project may be broken down into tasks or phases of work, or may be estimated as an entire project. The prediction may be based on control charts constructed with data collected when a similar project was performed previously, and may be generated manually or automatically. However, the predication may be obtained in any suitable way.

The service to the client is provided at block 803, and the actual costs are computed by block 804. The difference, V, between the actual and predicted costs may then be computed at block 805. In some embodiments, the process of performing the service may also be standardized to reduce unnecessary variation. As services are performed, a data series may be collected, which may be depicted on a control chart.

That data series, or data series acquired during prior service instances of the same type, may be used to compute control limits of the control chart. At block 806, these one or more data series may be used alone or aggregated to derive a data series reflecting the difference between actual and predicted costs. From the data series, an average value ( V̅) is obtained by block 808 and moving range values and average moving range value ( M̅R̅) are obtained by block 807. These averages, V̅ and M̅R̅, may be used to calculate the upper control limit and lower control limit by block 809.

The data series from block 806, the average value, V̅, from block 808, and the control limits from block 809 may be used to form the control chart at block 810. The data in the form of the control chart is then interpreted and analyzed at block 811 using the above mentioned techniques. Such an analysis may lead to the decision to implement changes by block 812 into the subsequent client service events, such as changing how predicted costs are estimated in block 802 and/or how client services are conducted in block 803.

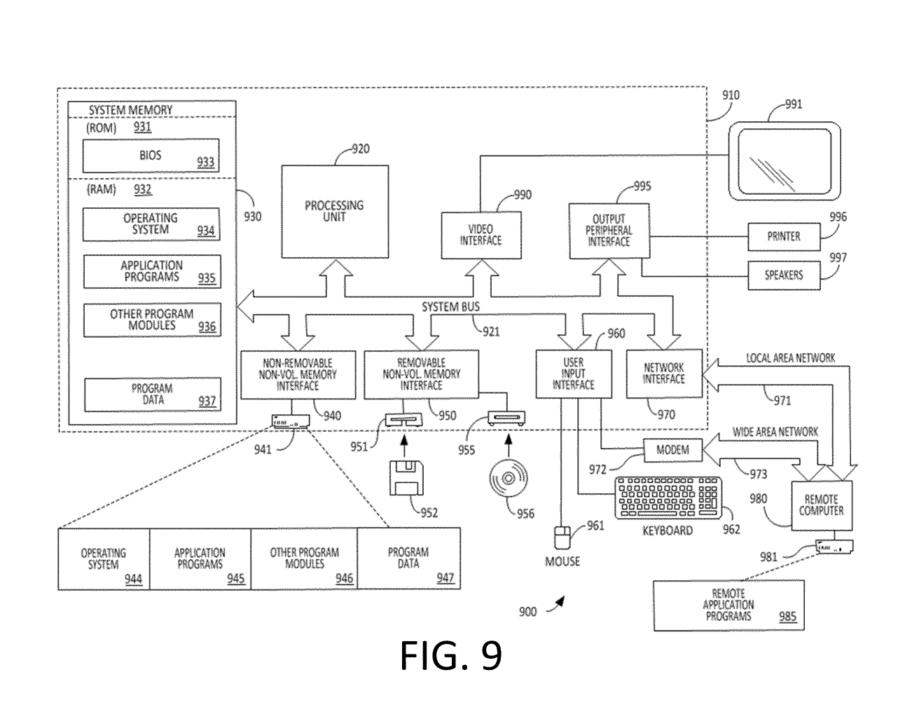

Creating an individual control chart, including collecting the data series, may be implemented on a computing system as part of an electronic tracking system. FIG. 9 illustrates an example of a suitable computing system environment 900 on which the invention may be implemented. The computing system environment 900 is only one example of a suitable computing environment and is not intended to suggest any limitation as to the scope of use or functionality of the invention. Neither should the computing environment 900 be interpreted as having any dependency or requirement relating to any one or combination of components illustrated in the exemplary operating environment 900.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 9, an exemplary system for implementing the invention includes a general purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through an non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of monitoring performance of professional services, the method comprising:
with at least one processor:
accessing a plurality of first values representing a prediction of values of a parameter of a process;
accessing a plurality of second values representing measured values of the parameter of the process;
computing a plurality of third values representing a difference between the plurality of second values and respective ones of the plurality of first values;
computing an upper limit and a lower limit based on statistical variation of at least a portion of the plurality of third values; and
representing the plurality of third values as a series with respect to the upper limit and the lower limit.

2. The method of claim 1, wherein the second values are derived from time entry inputs for a plurality of workers providing professional services on at least one project in accordance with the process.

3. The method of claim 2, wherein the first values represent a budget for performing the process.

4. The method of claim 2, wherein the second values are collected for multiple projects.

5. The method of claim 4, wherein the process comprises performing legal services to complete a project.

6. The method of claim 1, wherein values of the second values represent a value of a parameter recorded to reflect performance of respective tasks of the process.

7. The method of claim 1, further comprising with, the at least one processor:
computing a new upper limit and a new lower limit based on detection of statistical variation of the plurality of third values.

8. The method of claim 1, further comprising, displaying to a user a graphical depiction of the plurality of third values in relation to the upper limit and the lower limit.

9. The method of claim 8, wherein the graphical depiction is displayed while the process is ongoing.

10. The method of claim 8, further comprising with, the at least one processor:
computing a new upper limit and a new lower limit based on detection of statistical variation of the plurality of third values.

11. The method of claim 10, further comprising, with the at least one processor:
representing a portion of the plurality of third values on the graphical depiction as a series with respect to the new upper limit and the new lower limit.

12. The method of claim 1, further comprising with the at least one processor:
identifying a signal in the series representing the plurality of third values based on relative values of at least a portion of the plurality of third values and at least one of the upper limit and the lower limit.

13. The method of claim 12, wherein identifying the signal comprises:
detecting that a predetermined number of third values is greater than the upper limit or less than the lower limit.

14. The method of claim 12, further comprising with the at least one processor:
sending a message to a user when the signal is identified.

15. The method of claim 14, further comprising, initiating a corrective action in response to the message.

16. At least one non-transitory, tangible computer readable storage medium having computer-executable instructions, that when executed by a processor, perform a method of monitoring performance of professional services, the method comprising:
accessing a plurality of first values representing a prediction of values of a parameter of a process;
accessing a plurality of second values representing measured values of the parameter of the process;
computing a plurality of third values representing a difference between the plurality of second values and respective ones of the plurality of first values;
computing an upper limit and a lower limit based on statistical variation of the plurality of third values; and
representing, via a user interface, the plurality of third values as a series with respect to the upper limit and the lower limit;

17. The medium of claim 16, further comprising:
computing at least one new value representing a prediction of a value based on the statistical variation of the plurality of third values.

18. The medium of claim 16, further comprising:
identifying a signal in the series representing the plurality of third values based on relative values of at least a portion of the plurality of third values and at least one of the upper limit and the lower limit.

19. A system for monitoring performance of professional services, the system comprising:
a time tracking system;
at least one processor configured to:
access a plurality of first values representing a prediction of values of a parameter of a process;
access from the time tracking system a plurality of second values representing measured values of the parameter of the process;
compute a plurality of third values representing a difference between the plurality of second values and respective ones of the plurality of first values;
a software program configured to:
acquire the plurality of second values based on user activity;
organize the plurality of second values into at least one group corresponding to processes of the same type;
instruct the at least one processor to compute an upper limit and a lower limit based on statistical variation of the plurality of third values within the at least one group; and
a user interface configured to:
display a representation of the plurality of third values with respect to the upper limit and the lower limit.

20. The system of claim 19, wherein the system further comprises:
a billing system; and
accessing the plurality of first values comprises accessing the billing system.
